(19) United States
(12) Patent Application Publication
(10) Pub. No.: US 2024/0419117 A1
(43) Pub. Date: Dec. 19, 2024

(54) IMAGE READING DEVICE AND IMAGE FORMING APPARATUS

(71) Applicant: Konica Minolta, Inc., Tokyo (JP)

(72) Inventor: Daiki HIRATA, Tokyo (JP)

(21) Appl. No.: 18/678,485

(22) Filed: May 30, 2024

(30) Foreign Application Priority Data
Jun. 15, 2023 (JP) 2023-098167

(51) Int. Cl. G03G 15/00; G01J 3/52; H04N 1/00

(52) U.S. Cl. CPC G03G 15/6567; G01J 3/52; H04N 1/00702; H04N 1/00785; G03G 2215/00611

(57) ABSTRACT

An image reading device includes a conveyance path along which a recording medium is conveyed, a colorimeter that reads an image to be subjected to colorimetry, the image being recorded on the recording medium conveyed on the conveyance path, a detector that detects a position of the recording medium in a direction intersecting a conveyance direction of the recording medium; and a first hardware processor that controls the colorimeter so as to read the image to be subjected to colorimetry on a basis of a detection result by the detector.

### CROSS REFERENCE TO RELATED APPLICATIONS

The present invention claims priority under 35 U.S.C. § 119 to Japanese Application No. 2023-098167, filed on Jun. 15, 2023, the entire contents of which being incorporated herein by reference.

### BACKGROUND OF THE INVENTION

### Technical Field

The present invention relates to an image reading device and an image forming apparatus.

### Description of Related Art

The image forming apparatus reads a colorimetry chart. Furthermore, the image forming apparatus creates a color profile from the colorimetry chart. The colorimetry chart is an image in which a plurality of patch arrays each including a plurality of colorimetry patches are arranged in the sheet conveyance direction. A patch array includes a plurality of colorimetry patches arranged in a direction orthogonal to the sheet conveyance direction. Note that a direction orthogonal to the sheet conveyance direction is referred to as a scanning direction. The image forming apparatus forms the above-described colorimetry chart on a sheet. Furthermore, the image forming apparatus reads a colorimetry chart on the sheet.

The conventional image forming apparatus forms a predetermined end mark at each of both ends of the patch array. Furthermore, the image forming apparatus detects a start position of reading of a patch array by the end mark (e.g., JP 2016-24006A).

### SUMMARY OF THE INVENTION

In a conventional image forming apparatus, an end mark for detecting a start position of colorimetry is essential. Therefore, the conventional image forming apparatus needs to form the end mark on a recording medium. The end mark has narrowed an image region usable by a user on the recording medium. Furthermore, the end mark causes an increase in ink and toner consumption.

An object of the present invention is to enable an image forming apparatus to accurately read a patch without an end mark.

To achieve at least one of the abovementioned objects, according to an aspect of the present invention, an image reading device reflecting one aspect of the present invention includes:
a conveyance path along which a recording medium is conveyed;
a colorimeter that reads an image to be subjected to colorimetry, the image being recorded on the recording medium conveyed on the conveyance path;
a detector that detects a position of the recording medium in a direction intersecting a conveyance direction of the recording medium; and
a first hardware processor that controls the colorimeter so as to read the image to be subjected to colorimetry on a basis of a detection result by the detector.

To achieve at least one of the abovementioned objects, according to an aspect of the present invention, an image forming apparatus reflecting one aspect of the present invention includes:
an image former that records an image on a recording medium;
a conveyance path along which the recording medium is conveyed;
a colorimeter that reads an image to be subjected to colorimetry, the image being recorded, by the image former, on the recording medium conveyed on the conveyance path;
a detector that detects a position of the recording medium in a direction intersecting a conveyance direction of the recording medium; and
a first hardware processor that controls the colorimeter so as to read the image to be subjected to colorimetry on a basis of a detection result by the detector.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a front view illustrating a schematic configuration of an image forming apparatus according to a first embodiment,

FIG. 2 is a functional block diagram illustrating a control structure of the image forming apparatus according to the first embodiment,

FIG. 3 is a schematic diagram illustrating a configuration of an image reading device arranged in a second conveyance path,

FIG. 4 is a conceptual diagram illustrating a sheet skew correction operation by the corrector,

FIG. 5 is a diagram illustrating an example of a chart image,

FIG. 6 is a flowchart illustrating the contents of chart image reading processing,

FIG. 7 is a flowchart illustrating the contents of image forming control,

FIG. 8 is a schematic diagram illustrating a configuration of a part of an image reading device according to a second embodiment,

FIG. 9 is a schematic diagram illustrating a configuration of a part of the image reading device in a state where a sheet is conveyed more forward than the image reading device in the state in FIG. 8,

FIG. 10 is a flowchart illustrating the contents of chart image reading processing; and

FIG. 11 is a front view illustrating a schematic configuration of an image reading device in which an arrangement of a reader is changed.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

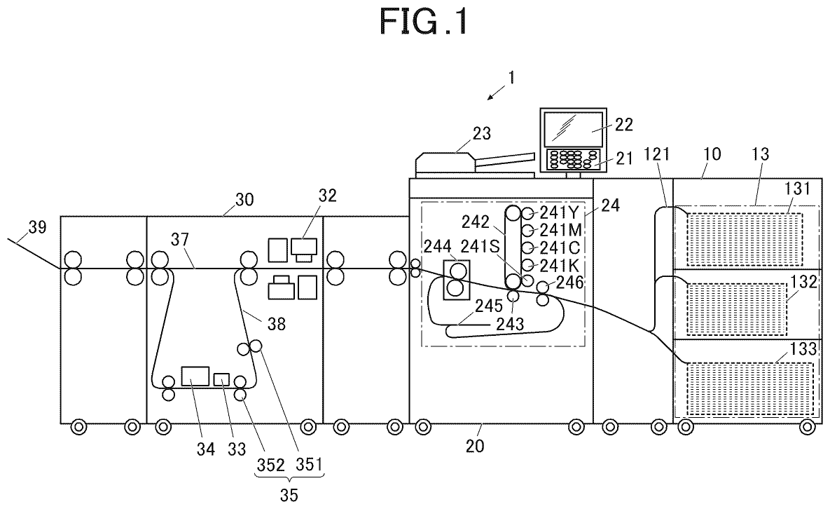

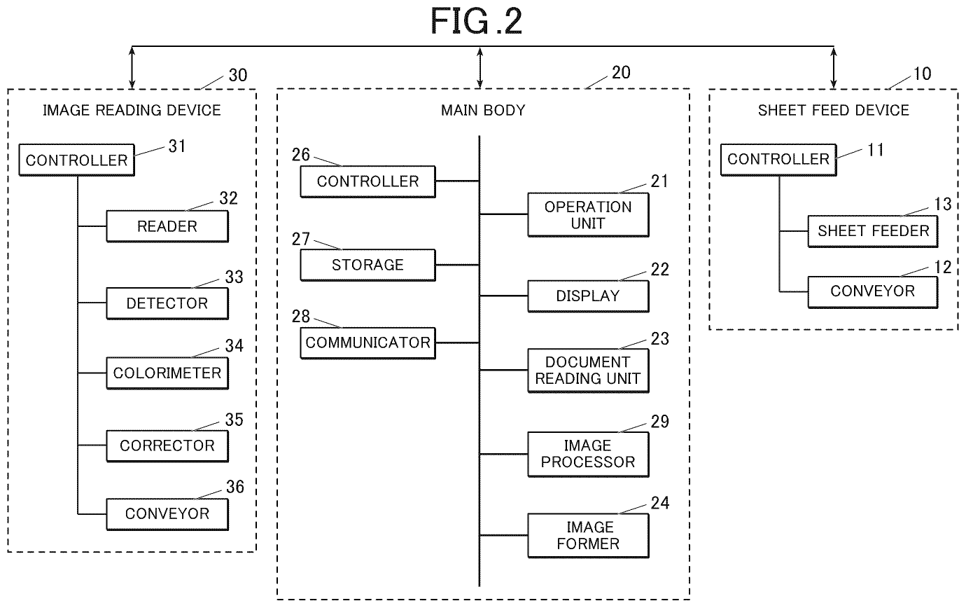

As illustrated in FIG. 1 and FIG. 2, an image forming apparatus 1 according to a first embodiment includes a sheet feed device 10, a main body 20, and an image reading device 30.

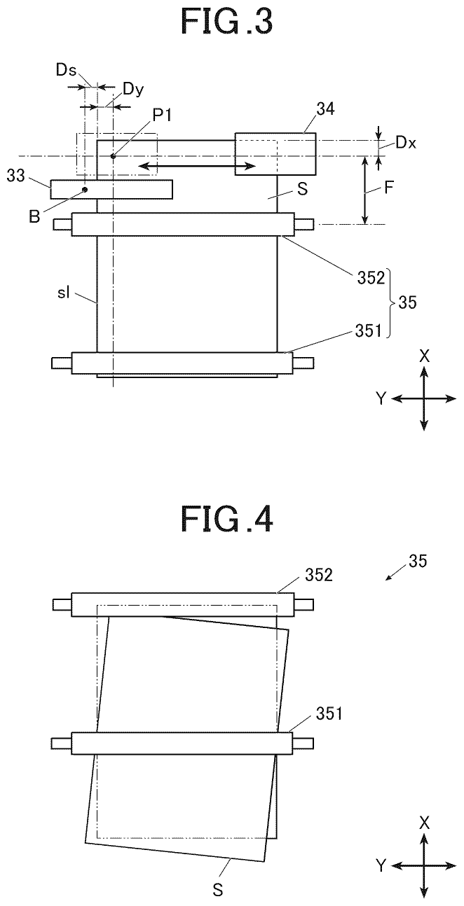

The sheet feed device 10, the main body 20, and the image reading device 30 are arranged in this order toward the downstream side in the conveyance direction of the recording medium. In the following description, a sheet S (see FIG. 3) is exemplified as a recording medium. A sheet conveyance path of the sheet feed device 10, a sheet conveyance path of the main body 20, and a sheet conveyance path of the image reading device 30 are connected to each other. Therefore, the sheets S are continuously conveyed from the sheet feed device 10 to the image reading device 30 via the main body 20.

### [Sheet Feed Device]

The sheet feed device 10 includes a controller 11, a conveyor 12, and a sheet feeder 13.

The controller 11 includes a CPU, a ROM, and a RAM. CPU is an abbreviation for Central Processing Unit. ROM is an abbreviation for Read Only Memory. RAM is an abbreviation for Random Access Memory.

The CPU of the controller 11 reads a program stored in the ROM and deploys the program on the RAM. The CPU integrally controls each unit of the sheet feed device 10 according to the deployed program.

For example, the controller 11 causes the conveyor 12 to convey the sheet S from one of the sheet feed trays 131, 132, and 133 of the sheet feeder 13 to the main body 20 according to a job.

The conveyor 12 includes a conveyance path 121 and a plurality of conveyance rollers (not illustrated). The conveyance path 12 connects the sheet feeder 13 and the main body 20. The plurality of conveyance rollers convey the sheet S in the conveyance path 121.

The sheet feeder 13 includes a plurality of sheet feed trays 131, 132, and 133. A user stores a predetermined sheet type of sheets S or a predetermined size of sheets S in each of the sheet feed trays 131, 132, and 133.

The image forming apparatus 1 may include a detection device that detects a physical property of the sheet S between the sheet feed device 10 and the main body 20.

### [Main Body]

The main body 20 is located on the downstream side in the sheet conveyance direction of the sheet feed device 10. Furthermore, the main body 20 is located on the upstream side in the sheet conveyance direction of the image reading device 30.

The main body 20 acquires image data. The image data is image data obtained by reading an image from a document and/or image data received from an external device (not illustrated). Then, the main body 20 forms a color image on a sheet S by an electrophotographic method on the basis of the image data. Furthermore, the main body 20 conveys the sheet S on which an image has been formed to the image reading device 30.

As illustrated in FIG. 1 and FIG. 2, the main body 20 has the following configuration. The main body 20 includes an operation unit 21, a display 22, a document reading unit 23, an image former 24, a controller 26 (i.e., a second hardware processor), a storage 27, a communicator 28, and an image processor 29 (i.e., a second hardware processor).

The operation unit 21 includes a touch panel and various operation buttons such as numeric buttons and a start button. The touch panel is provided so as to cover the display screen of the display 22.

The operation unit 21 outputs an operation signal based on a user's operation to the controller 26.

The display 22 includes a liquid crystal display (LCD) or the like.

The display 22 displays various screens according to a command of a display signal input from the controller 26.

The document reading unit 23 includes an automatic document feeder (ADF), a scanner and the like. ADF is an abbreviation for Automatic Document Feeder.

The document reading unit 23 generates image data from a document. Furthermore, the document reading unit 23 outputs the image data to the controller 26.

The sheet S is conveyed to the image former 24 from the sheet feed device 10. The image former 24 forms, on the sheet S, an image based on image data by an intermediate transfer method. In the present embodiment, a flat sheet is exemplified as the sheet S.

The image former 24 includes a photosensitive drum, an intermediate transfer belt 242, a secondary transfer roller 243, a fixing unit 244, a reversing path 245, a register 246, and the like. The image former 24 includes photosensitive drums corresponding to respective colors of yellow (Y), magenta (M), cyan (C), black (K), and special color(S). In the present embodiment, white is exemplified as the special color. That is, the image former 24 includes photosensitive drums 241Y, 241M, 241C, 241K, and 241S.

The image former 24 uniformly charges the photosensitive drum 241Y. Thereafter, the image former 24 scans and exposes the photosensitive drum 241Y with a laser beam on the basis of the image data for yellow to form an electrostatic latent image on the photosensitive drum 241Y. Next, the image former 24 causes yellow toner to adhere to the electrostatic latent image on the photosensitive drum 241Y. Thus, the image former 24 performs development on the surface of the photosensitive drum 241Y.

The image former 24 also performs development on the photoconductor drums 241M, 241C, 241K, and 241S with toners of the respective colors.

The image former 24 transfers the toner images of the respective colors formed on the photosensitive drums 241Y, 241M, 241C, 241K, and 241S onto the intermediate transfer belt 242. The transfer onto the intermediate transfer belt 242 is referred to as primary transfer. The image former 24 forms a color toner image in which toner images of five colors are overlapped one another on the intermediate transfer belt 242.

The image former 24 collectively transfers the color toner image on the intermediate transfer belt 242 onto a sheet S by a secondary transfer roller 243. The transfer onto the sheet S is referred to as secondary transfer. The secondary transfer is performed at a nip between the intermediate transfer belt 242 and a secondary transfer roller 243.

The fixing unit 244 includes a heating roller and a pressure roller. The heating roller heats the sheet S on which the color toner image has been transferred. The pressure roller pressurizes the sheet S toward the heating roller side.

The fixing unit 244 fixes the color toner image to the sheet S by heating and pressurizing.

Single-sided printing is a printing method for forming an image on one side of a sheet S. When single-sided printing is performed in the main body 20, the controller 26 conveys the sheet S from the fixing unit 244 to the image reading device 30.

Double-sided printing is a printing method for forming an image on each of both sides of a sheet S. When double-sided printing is performed in the main body 20, the controller 26 conveys the sheet S from the fixing unit 244 to the reversing path 245 and reverses the side of the sheet. Next, the controller 26 feeds the sheet S again to the upstream side of the register 246 in the sheet conveyance direction.

The register 246 includes a registration roller. The register 246 conveys a sheet S to a transfer unit.

The register 246 corrects a skew of the sheet S conveyed from the sheet feed device 10. Furthermore, the register 246 adjusts the conveyance timing of the sheet S.

The controller 26 includes a CPU, a RAM, a ROM, and the like.

The CPU of the controller 26 reads various processing programs stored in the ROM and deploys the programs in the RAM. The controller 26 comprehensively controls the operation of the main body 20 in cooperation with various programs deployed in the RAM.

The storage 27 stores various types of data such as programs and image data. The storage 27 is, for example, a non-volatile storage device such as an HDD or a semiconductor memory. HDD is an abbreviation for Hard Disk Drive.

The controller 26 can read and write program data, various types of setting data, and the like stored in the storage 27.

In addition, the storage 27 stores information such as a basis weight, a size, and a sheet type of the sheet S stored in each of the sheet feed trays 131, 132, and 133.

The communicator 28 includes a communication control card such as a LAN card.

The communicator 28 exchanges various types of data with an external device connected to a communication network such as a LAN or a WAN. The external device is, for example, a personal computer. LAN is an abbreviation for Local Area Network. WAN is an abbreviation for Wide Area Network.

The image processor 29 performs image processing necessary for image formation on image data. Images to be subjected to image processing include image data stored in the storage 27, image data obtained by reading a document by the document reading unit 23, and image data input from an external device.

The image processor 29 transmits the image data after the image processing to the image former 24.

The image processing includes gradation processing, halftone processing, and color conversion processing.

The gradation processing is processing for converting a gradation value of each pixel of the image data. The conversion of the gradation value is performed so that a density characteristic of the image formed on the sheet S matches a target density characteristic.

The halftone processing includes error diffusion processing, and screen processing using a systematic dither method.

The color conversion processing is processing for converting each gradation value of RGB into each gradation value of CMYK.

The above-described image processor 29 may be a CPU of the controller 26 that performs the function of the image processor 29 by a program.

### [Image Reading Device]

The image reading device 30 is arranged on a downstream side in the sheet conveyance direction of the main body 20.

The image reading device 30 reads the sheet S conveyed from the main body 20. Furthermore, the image reading device 30 outputs data of the read image of the sheet S to a controller 31 (i.e., first hardware processor).

The image reading device 30 includes the controller 31, a reader 32, a conveyor 36, a detector 33, and a colorimeter 34. The image reading device 30 further includes a corrector 35 and a sheet ejection tray 39.

The conveyor 36 includes a conveyance path and conveying path and a conveyance roller (not illustrated). The conveyance path connects the main body 20 and the sheet ejection tray 39. The conveyance roller conveys the sheet S in the conveyance path.

The above-described conveyance path includes a first conveyance path 37 and a second conveyance path 38. The first conveyance path 37 connects the main body 20 and the sheet ejection tray 39 substantially linearly. The second conveyance path 38 branches from the middle of the first conveyance path 37, detours downward, and then is joined to the first conveyance path 37 again.

When the second conveyance path 38 branches from the first conveyance path 37, the second conveyance path 38 greatly detours downward. Furthermore, the second conveyance path 38 extends upward and is joined to the first conveyance path 37.

The conveyance distance of the sheet S conveyed to the second conveyance path 38 is longer than that of the sheet S conveyed only to the first conveyance path 37.

Both of the first conveyance path 37 and the second conveyance path 38 may be formed with guides or walls for guiding the sheet S along the conveyance paths. Furthermore, the first conveyance path 37 and the second conveyance path 38 may be formed by a plurality of guide rollers arranged side by side along the respective paths.

At a branch position from the first conveyance path 37 to the second conveyance path 38, a branch guide (not illustrated) capable of changing a route of the sheet S is arranged. The direction of the branch guide can be changed by an actuator. The controller 31 controls the actuator. By changing the direction of the sorting member, the conveyance path of the sheet S can be switched to the first conveyance path 37 or the second conveyance path 38.

On the first conveyance path 37, the reader 32 is arranged on the upstream side in the sheet conveyance direction relative to the position where the first conveyance path 37 branches from the second conveyance path 38.

The reader 32 reads an image formed on the sheet S by the image former 24. Furthermore, the reader 32 outputs the read image data of the image formed on the sheet S to the image processor 29. The reader 32 is constituted by, for example, a color scanner. The reader 32 is arranged on a downstream side of the image former 24 in the sheet conveyance direction. This enables the reader 32 to read the image while the sheet is being conveyed.

The reader 32 also includes individual detection elements on the upper and lower sides across the sheet S conveyed on the first conveyance path 37. The upper detection element reads an image on one side, for example, the upper side of the sheet S. The lower detection element reads an image on the other side, for example, the lower side of the sheet S.

The read image read by the reader 32 is analyzed by the image processor 29. The image processor 29 performs not only image processing on image data before image formation but also analysis on an image read by the reader 32. The image processor 29 calculates a misregistration amount of an image formed on each of a front side and a back side of the sheet S with respect to the sheet S, a misregistration adjustment amount, an image color adjustment amount, and the like. The image processor 29 also detects a defect in the formed image. The image processor 29 outputs the analysis result to the controller 26 of the main body 20.

Furthermore, the controller 31 performs various types of calibration on the basis of the read image read by the reader 32.

FIG. 3 is a schematic diagram illustrating a configuration of the image reading device 30 arranged in the second conveyance path 38. An X-axis direction illustrated in FIG. 3 indicates a sheet conveyance direction, and a Y-axis direction indicates a direction orthogonal to the sheet conveyance direction.

Note that the “direction orthogonal to the sheet conveyance direction” indicates a direction parallel to the plane of the conveyed sheet and orthogonal to the sheet conveyance direction. Hereinafter, the “direction orthogonal to the sheet conveyance direction” is referred to as a “conveyance orthogonal direction”.

Furthermore, the lower side in FIG. 3 indicates the upstream side in the sheet conveyance direction, and the upper side in FIG. 3 indicates the downstream side in the sheet conveyance direction.

In the second conveyance path 38, the corrector 35, the detector 33, and the colorimeter 34 are arranged in this order toward the downstream side in the sheet conveyance direction.

The corrector 35 corrects the skew of the sheet S conveyed along the second conveyance path 38. When the sheet S has a rectangular shape, the sheet S is preferably conveyed in a state where a side end s1 of the sheet S is parallel to the sheet conveyance direction.

Note that the side end of the sheet S refers to an end along a short side or a long side of the rectangular sheet S. In the following description, there will be exemplified a case where the sheet S is conveyed so that the end along the long side is parallel to the conveyance direction.

The corrector 35 corrects the orientation of the sheet S so that the side end s1 of the sheet S becomes close to a state of being parallel to the sheet conveyance direction.

The corrector 35 includes a loop roller 351 and a registration roller 352. The loop roller 351 and the registration roller 352 each includes a roller pair that rotates about an axis extending in the conveyance orthogonal direction. Two rollers constituting each roller pair rotate in opposite directions to each other. This can cause the roller pair to feed the sheet S passing through the nip of the roller pair in the conveyance direction.

The loop roller 351 is arranged on the upstream side in the conveyance direction relative to the registration roller 352. The interval in the sheet conveyance direction between the loop roller 351 and the registration roller 352 is shorter than a predetermined distance. The predetermined distance indicates a length along the conveyance direction of a minimum sheet S to be conveyed.

Furthermore, spaces for allowing a loop (slack) generated in the sheet S are secured between the loop roller 351 and the registration roller 352. These spaces are spaces formed on both sides of the second conveyance path 38 in a direction perpendicular to the plane of the conveyed sheet S.

Furthermore, the loop roller 351 and the registration roller 352 each include a motor serving as a rotation driving source. The controller 31 can individually control the driving and stopping of each motor. That is, the corrector 35 corrects the skew of the sheet S by cooperation of the corrector 35 and the controller 31.

FIG. 4 is a conceptual diagram illustrating a skew correction operation of the sheet S by the corrector 35.

The controller 31 stops the driving of the motor of the registration roller 352 at the start of the correction operation by the corrector 35.

On the other hand, the controller 31 controls the motor so that the loop roller 351 conveys the sheet S toward the registration roller 352 side.

As a result, the front end of the sheet S on the downstream side in the sheet conveyance direction is pressed against the nip of the registration roller 352. The nip of the registration roller 352 is parallel to the conveyance orthogonal direction.

As indicated by the solid line in FIG. 4, the sheet S may have a skew with respect to the sheet conveyance direction before the sheet S is pressed against the registration roller 352. In this case, when the sheet S is pressed against the registration roller 352, as illustrated by a two-dot chain line, the orientation of the front end of the sheet S is corrected so that the front end follows the nip and extends along the conveyance orthogonal direction. In addition, the side end of the sheet S may be slack to form a loop.

In this state, the controller 31 controls the motor of the registration roller 352 to perform rotational drive in the sheet conveyance direction. This can cause the registration roller 352 to feed the sheet S in a state where the side end of the sheet S extends along the sheet conveyance direction.

The detector 33 detects a position of the sheet S in the conveyance orthogonal direction. To be more specific, the detector 33 can detect the position in the conveyance orthogonal direction of the side end s1 of the sheet S on one side in the conveyance orthogonal direction.

The detector 33 includes, for example, a line sensor. As illustrated in FIG. 3, the detector 33 is arranged so that the linear detection range is parallel to the conveyance orthogonal direction. A detection surface of the detector 33 is directed toward the conveyed sheet S.

The detector 33 may include a light source to irradiate the sheet S. The detector 33 can detect the position in the conveyance orthogonal direction of the side end s1 of the sheet S by a difference in the luminance of the reflected light.

A detection range of the detector 33 includes a position where the side end s1 at at least one side in the conveyance orthogonal direction of the sheet S conveyed on the second conveyance path 38 can pass. Note that the misregistration of the sheet S may occur in any direction of the conveyance orthogonal directions in the second conveyance path 38. The detector 33 preferably has a detection range capable of sufficiently coping with a misregistration which may occur in the conveyance orthogonal direction of the sheet S.

The colorimeter 34 reads a chart image O recorded on the sheet S being conveyed on the second conveyance path 38.

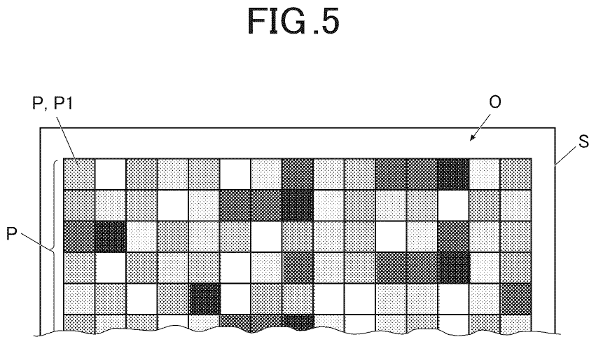

Here, the chart image O (ou) recorded on the sheet S will be described. The chart image O is a calibration chart including a plurality of patches P which are a plurality of images to be subjected to colorimetry in which a combination of gradation values is determined in advance. FIG. 5 is a diagram illustrating an example of the chart image O.

The chart image O will be described on the assumption that the sheet S illustrated in FIG. 5 is arranged on the conveyance path in an appropriate orientation.

The chart image O is an image in which a plurality of patch arrays each including a plurality of patches P are arranged in the sheet conveyance direction. Each of the patch arrays includes a plurality of patches P arranged in a row along the conveyance orthogonal direction. FIG. 5 illustrates a case where the patch P has a square shape, but the patch P may have any other shape such as a rectangular shape. All of the patches P have the same shape and size. In addition, each patch P or each patch array may be formed without a gap, or may be provided with a gap.

A gradation value indicating the hue of each patch P is preferably different among all the patches P.

The chart image O is formed on one side of the sheet S by the image former 24 of the main body 20. The colorimeter 34 reads each patch P of the chart image O formed by the image former 24.

The colorimeter 34 is constituted by a spectral colorimeter. The colorimeter 34 can perform colorimetry with higher accuracy than the reader 32 constituted by a color scanner.

The colorimeter 34 individually measures all the patches P of the chart image O and outputs the measurement results to the controller 31. The controller 31 compares a predetermined gradation value for each patch P of the chart image O with the gradation value measured by the colorimeter 34. Then, the controller 31 creates a so-called color profile by the comparison.

The controller 31 sends the color profile to the main body 20. The color profile is referred to by the controller 26 at the time of image formation by the image former 24. When image formation is performed by the image former 24, the controller 26 reflects the color profile in the correction of the hue.

As described above, the colorimeter 34 individually measures the plurality of patches P regularly arranged in the conveyance orthogonal direction. Therefore, the colorimeter 34 is conveyed by a carriage-type conveyance mechanism (not illustrated). Under the control of the controller 31, the conveyance mechanism can convey the colorimeter 34 along the conveyance orthogonal direction and arbitrarily perform the positioning of the colorimeter 34.

A patch P1 of the chart image O illustrated in FIG. 5 indicates a patch serving as a measurement start position by the colorimeter 34. That is, the patch P1 is a patch belonging to the patch array on the most downstream side in the sheet conveyance direction. Furthermore, the patch P1 is a patch located at one end in the conveyance orthogonal direction in the patch array. The patch P1 may be closest to the detector 33 in the patch array. As described above, the measurement start position of the chart image O is preferably the position of the patch P located at the corner in the downstream-side end in the sheet conveyance direction.

The controller 31 can acquire the positions of all the patches P in the conveyance orthogonal direction and the sheet conveyance direction in the plane of the sheet S from the image data of the chart image O. Therefore, it can be said that the positions of all the patches P are known. Note that the “position of the patch” referred to herein includes a position of a corner of the patch and a center position of the patch.

A long dashed line along the X-axis direction in FIG. 3 is a straight line along the sheet conveyance direction that passes through the position of the patch P1. As described above, the controller 31 can acquire the position of the patch P1 in the plane of the sheet S from the image date of the chart image O. Therefore, the controller 31 can also acquire a distance Dy in the conveyance orthogonal direction from the side end s1 of the sheet S to the position of the patch P1.

The controller 31 can control the detector 33 to detect the position in the conveyance orthogonal direction of the side end s1 of the sheet S. This enables the controller 31 to acquire the position of the patch P1 in the transport orthogonal direction, that is, the measurement start position in the transport orthogonal direction.

For example, it is assumed that a distance Ds in the conveyance orthogonal direction from a reference position B in the conveyance orthogonal direction to the side end s1 of the sheet S is detected by the detector 33. Note that the reference position B is a target position through which the side end s1 of the appropriately conveyed sheet S should pass. The position in the conveyance orthogonal direction of the reference position B is known.

In that case, the controller 31 calculates the position of the patch P1 in the conveyance orthogonal direction by Ds+Dy.

Thus, the controller 31 controls the conveyance mechanism of the colorimeter 34 so that the reading start position is Ds+Dy at the start of reading of the chart image O.

Note that for reading of the chart image O, it is also necessary to perform relative positioning between the sheet S and the colorimeter 34 in the sheet conveyance direction.

The positioning in the sheet conveyance direction is achieved by the above-described control of the rotation amount of the registration roller 352.

The controller 31 can acquire, from a design value, a distance F from the registration roller 352 to the colorimeter 34 in the sheet conveyance direction. Furthermore, the controller 31 can also acquire the positions of the patches P1 in the sheet conveyance direction on the sheet S from the image date of the chart image O. Therefore, it is also possible to acquire a distance Dx in the sheet conveyance direction from the end on the downstream side of the sheet S in the sheet conveyance direction to the position of the patch P1.

Therefore, the controller 31 controls the motor so that the feeding by the registration roller 352 is performed by the distance (F+Dx) from the start of driving of the motor during the above-described skew correction by the corrector 35.

This enables the controller 31 to position the colorimeter 34 at the reading start position in the sheet conveyance direction.

Note that in order to more accurately detect the feed amount of the sheet S in the sheet conveyance direction, the registration roller 352 may be provided with a sensor such as an encoder for detecting the number of rotations of the registration roller 352.

### [Reading of Chart Image by Image Reading Device]

The image forming apparatus 1 can selectively execute a colorimetry mode and a non-colorimetry mode. In the colorimetry mode, the image forming apparatus 1 performs formation to reading of the chart image O. In the non-colorimetry mode, the image forming apparatus 1 performs image formation on the basis of arbitrary image data.

These modes can be selected by an operator using the operation unit 21 of the main body 20.

When the operator selects the colorimetry mode, the controller 26 of the main body 20 reads image data of the chart image O prepared in the storage 27. In addition, the controller 26 transmits the execution of the colorimetry mode to the controller 31 of the image reading device 30.

Next, the controller 26 requests the sheet feed device 10 to convey a predetermined sheet S for forming the chart image O.

Then, the controller 26 controls the image former 24 to form the chart image O on the sheet S supplied from the sheet feed device 10 on the basis of the image data.

Then, the controller 26 conveys the sheet S on which the chart image O is formed to the image reading device 30.

Next, chart image reading processing performed by the controller 31 of the image reading device 30 will be described.

The chart image reading processing is executed by the CPU of the controller 31 according to a program read from the storage 27 of the main body 20 by the CPU.

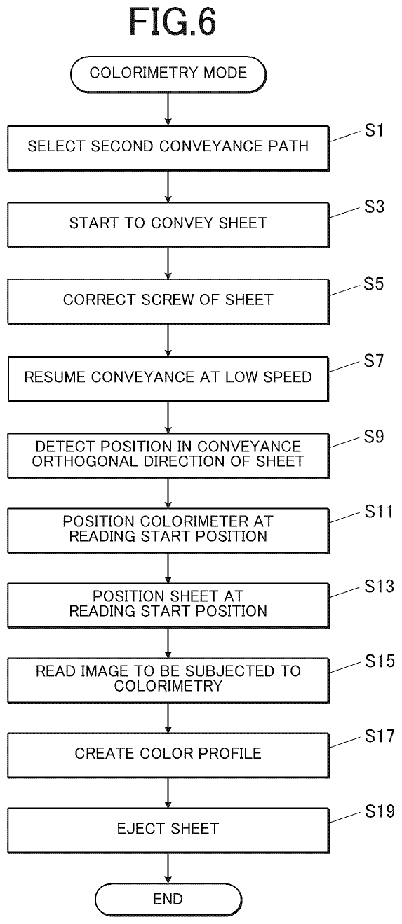

FIG. 6 is a flowchart illustrating the contents of chart image reading processing. The contents of the chart image reading processing will be described with reference to FIG. 3 to FIG. 6.

When the controller 31 receives a command to execute the colorimetry mode from the main body 20, the controller 31 controls the branch guide of the conveyor 36. This enables the sheet S to be conveyed to the second conveyance path 38 (S1).

Next, the controller 31 controls the conveyor 36 to start conveyance of the sheet S (S3).

In this case, the conveyance speed of the sheet S may be lower than that in the non-colorimetry mode, or may be equal to that in the non-colorimetry mode.

Then, the sheet S on which the chart image O has been formed is guided from the main body 20 to the second conveyance path 38.

When the sheet S arrives at the registration roller 352, the corrector 35 performs skew correction (S5). Note that the corrector 35 may be provided with a sensor for detecting the arrival of the sheet S. The sensor may detect a downstream-side end in the sheet conveyance direction of the sheet S. The sensor may be arranged around or in front of the nip of the loop roller 351 or the registration roller 352.

As shown in FIG. 4, the controller 31 drives the loop roller 351 with respect to the registration roller 352 in a stopped state. Thus, the skew of the sheet S is corrected so that the downstream-side end in the sheet conveyance direction of the sheet S is substantially parallel to the conveyance orthogonal direction.

Then, the controller 31 drives the registration roller 352 and the loop roller 351 to resume conveyance of the sheet S (S7).

In this case, the conveyance speed of the sheet S is set to be lower than that in the non-colorimetry mode. Thus, the controller 31 functions as a “conveyance controller”.

With respect to the conveyed sheet S, the detector 33 detects the position in the conveyance orthogonal direction of the side end s1 (S9).

The controller 31 calculates the position in the conveyance orthogonal direction of the patch P1 of the chart image O from the detected position in the conveyance orthogonal direction of the side end s1. Then, the controller 31 controls the conveyance mechanism to perform the positioning of the colorimeter 34 so that the position in the conveyance orthogonal direction of the patch P1 becomes the reading start position (S11).

The controller 31 functions as a “colorimetry controller” by performing control to perform the positioning of the colorimeter 34.

The controller 31 controls each motor of the registration roller 352 and the loop roller 351 to perform the positioning of the patch P1 on the sheet S in the sheet conveyance direction (S13). In this case, positioning is performed so that the position of the patch P1 on the sheet S coincides with the reading position of the colorimeter 34 in the sheet conveyance direction. By this positioning, the driving of each motor of the registration roller 352 and the loop roller 351 is temporarily stopped.

Note that the controller 31 may execute the processing by exchanging the processes of S11 and the S13. Furthermore, the controller 31 may perform the processes of S11 and S13 concurrently.

By the processes of the S11 and the S13, the position of the patch P1 on the sheet S and the reading position of the colorimeter 34 substantially coincide with each other in plan view.

The controller 31 executes reading of each patch P by the colorimeter 34 sequentially from this state (S15).

First, the controller 31 executes the colorimetry of each patch P while conveying the colorimeter 34 to the end on the side opposite to the patch P1 of the patch array along the conveyance orthogonal direction. Hereinafter, the operation of reading one patch array by the colorimeter 34 is referred to as scanning.

Furthermore, the controller 31 controls each motor of the registration roller 352 and the loop roller 351 to convey the sheet S in the above-described low-speed state.

Thereafter, the controller 31 executes scanning of the colorimeter 34 for each patch array.

Note that the controller 31 may perform colorimetry every time the colorimeter 34 moves in the same direction with respect to a plurality of patch arrays during scanning of the colorimeter 34.

Alternatively, the controller 31 may alternately perform the colorimetry during the movement in the outward path along the conveyance orthogonal direction and the colorimetry during the movement in the return path with respect to the plurality of patch arrays during the scanning of the colorimeter 34.

Upon completion of reading of the chart image O, the controller 31 compares the read data with the image data of the chart image O. Then, the controller 31 creates a color profile of the image former 24 (S17). The controller 31 transmits the color profile to the controller 26 of the main body 20.

Then, the controller 31 controls the conveyor 36 to eject the sheet S to the sheet ejection tray 39 (S19), and ends the reading processing in the colorimetry mode.

Note that the controller 31 may transmit the read date of the chart image O to the controller 26 of the main body 20 without creating a color profile in S17. In this case, the controller 26 of the main body 20 that has received the read data creates a color profile.

### [Image Formation by Main Body]

Image formation control in the main body 20 after the color profile is acquired will be described. The image formation control is executed by the CPU of the controller 26 according to a program read from the storage 27 by the CPU.

Note that the CPU of the controller 26 executes the image formation processing when the operator selects the non-colorimetry mode.

Therefore, the controller 26 transmits the execution of the non-colorimetry mode to the controller 31 of the image reading device 30. Thus, the controller 31 of the image reading device 30 controls the branch guide of the conveyor 36 to stand by in a state where the sheet S can be conveyed only on the first conveyance path 37.

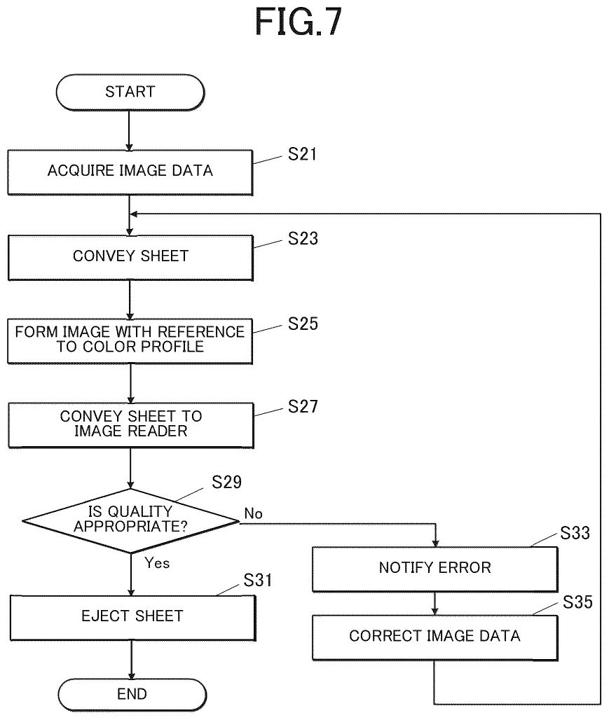

FIG. 7 is a flowchart illustrating the contents of image forming control. The contents of the image forming control will be described with reference to FIG. 7.

The controller 26 acquires image date (S21). The image data may be acquired from the document reading unit 23, or may be image data received from an external device (not illustrated).

Then, the controller 26 requests the sheet feed device 10 to convey the sheet S (S23).

The acquired image data is subjected to image processing such as gradation processing, halftone processing, and color conversion processing by the image processor 29. Furthermore, the controller 26 or the image processor 29 corrects the gradation value of the image data with reference to the color profile acquired from the image reading device 30.

Then, the controller 26 controls the image former 24 to form an image on the conveyed sheet S on the basis of the corrected image date (S25).

Then, the controller 26 conveys the sheet S on which the image has been formed, to the image reading device 30 (S27).

The reader 32 is arranged on the upstream side in the sheet conveyance direction in the first conveyance path 37 of the image reading device 30. Therefore, by the conveyance of the sheet S to the image reading device 30, the controller 26 can promptly acquire, via the controller 31, read image data of the sheet S by the reader 32.

The image processor 29 analyzes image data read by the reader 32. The image processor 29 detects a misregistration amount of the formed image with respect to the sheet S, and a defect of the formed image.

The controller 26 determines the quality of the formed image on the basis of the detection result of the image processor 29 (S29).

If the controller 26 determines that the qualities of the formed image is appropriate, the controller 26, through the controller 31, causes the sheet S to be ejected to the sheet ejection tray 39 without being processed (S31). Then, controller 26 ends the image formation control.

On the other hand, if determining that the quality of the formed image is inappropriate, the controller 26 allows the display 22 to display an image formation error for notification (S33).

Furthermore, the controller 26 corrects the image date by the misregistration adjustment amount, the image color adjustment amount, and the like which are obtained by the image analysis by the image processor 29 (S35). Thus, the controller 26 and the image processor 29 cooperate with each other to function as an “image controller”.

Then, the controller 26 returns the process to S23 and performs image formation again on a newly supplied sheet S.

### Technical Effects of First Embodiment

In the image reading device 30 of the image forming apparatus 1, the controller 31 controls the colorimeter 34 to read the patch P on the basis of the detection result by the detector 33.

This enables the colorimeter 34 to appropriately read the patch P even when the misregistration of the sheet S occurs in the conveyance orthogonal direction in the second conveyance path 38. Furthermore, even when the position in the conveyance orthogonal direction of the sheet S in the second conveyance path 38 varies, the colorimeter 34 can appropriately read the patch P.

Therefore, the image forming apparatus 1 can acquire a more accurate color profile and can form a high-quality image.

In addition, it is unnecessary to add an end mark to the end of the patch array unlike the conventional technique. Therefore, the image forming apparatus 1 does not need to secure a region for forming the end mark on the sheet S. Therefore, a region of the sheet S that can be used by a user is expanded. Furthermore, since no end mark is required, the image forming apparatus 1 can reduce toner consumption.

The controller 31 also controls the reading position of the colorimeter 34 on the basis of the detection result of the detector 33. Therefore, the colorimeter 34 can read each patch P at an appropriate position in the conveyance orthogonal direction. Therefore, the image reading device 30 can obtain an accurate reading result of the chart image O.

In the image reading device 30 of the image forming apparatus 1, the colorimeter 34 is movable along the conveyance orthogonal direction.

Therefore, the image reading device 30 does not require a huge sensor that extends over the entire width of the sheet S, and the image reading device 30 can use a small detection element or the like.

In particular, in a case where the colorimeter 34 is movable, reading of the patches P arranged along the patch array can be satisfactorily performed. Therefore, the image reading device 30 can suitably adapt the detection result by the detector 33 to the control of the reading position.

This enables the image reading device 30 to obtain an accurate reading result of the chart image O.

In addition, a plurality of patches P are recorded on the chart image O of the sheet S along the conveyance orthogonal direction. Therefore, when the colorimeter 34 is movable along the conveyance orthogonal direction, the colorimeter 34 can read each patch P particularly well.

This enables the image reading device 30 to obtain an accurate reading result of the chart image O.

The controller 31 performs control to determine the reading start position of the colorimeter 34 on the basis of the detection result by the detector 33. Both of the arrangement direction of the patches P constituting the patch array of the chart image O and the moving direction of the colorimeter 34 are the conveyance orthogonal direction. Therefore, when the reading start position of the colorimeter 34 is determined, appropriate reading can be performed on the entire patch array. Therefore, the image reading device 30 can satisfactorily read each patch P with simple control.

The controller 31 also adjusts the position of the colorimeter 34 in the conveyance orthogonal direction before the colorimeter 34 starts to read the patch P.

This enables the image reading device 30 to accurately perform colorimetry at the same time as the start of reading of the patch P.

In the image reading device 30, the detector 33 is arranged on the upstream side in the sheet conveyance direction relative to the colorimeter 34.

Therefore, even when the patch P is formed on any position on the sheet S, the colorimeter 34 can read the patch P using the detection result of the detector 33. Therefore, the formation range of the patch P on the plane of the sheet S can be expanded. Therefore, the patches P can be formed at a high density in the chart image O.

The colorimetry controller 31 can selectively execute a colorimetry mode and a non-colorimetry mode. Therefore, the image reading device 30 can avoid the colorimetry by the colorimeter 34 if such colorimetry is unnecessary. In that case, the frequency of the operation and the detection of the colorimeter 34 can be reduced, and the image reading device 30 can reduce the operation loads of the driver and the colorimeter 34 and the processing load of the detection data.

The image reading device 30 includes a corrector 35 on the upstream side in the conveyance direction relative to the colorimeter 34. Therefore, the skew of the sheet S can be reduced, and the reading of the patches P by the colorimeter 34 can be performed with higher accuracy.

Furthermore, the detector 33 is arranged on the downstream side in the sheet conveyance direction relative to the corrector 35. Therefore, the corrector 35 can correct the skew of the sheet S prior to the detection by the detector 33.

Accordingly, the detector 33 detects the position of the sheet S in a state where the skew of the sheet S has been corrected, and thus can perform more appropriate detection. Therefore, the colorimeter 34 can read each patch P with higher accuracy.

The controller 31 performs control in the colorimetry mode so that the conveyance speed of the sheet S when the sheet S passes through the colorimeter 34 is lower than that in the non-colorimetry mode.

This enables the image reading device 30 to achieve reading of the patch P by the colorimeter 34 with higher accuracy.

The colorimeter 34 includes a spectral colorimeter. Therefore, the colorimeter 34 can read the patch P with higher accuracy than a color scanner or the like.

The image forming apparatus 1 further includes the reader 32 that reads an image recorded on the sheet S by the image former 24. Then, the image processor 29 corrects the image data on the basis of a reading result of the image by the reader 32. Furthermore, the controller 26 controls the image former 24 to form an image according to the corrected image data.

This enables the image forming apparatus 1 to form a high-quality image.

In addition, in the image forming apparatus 1, the color profile is created on the basis of the reading result of the chart image O by the colorimeter 34. Furthermore, at the time of the above-described correction of image data, a color profile is referred to, and the image data is also corrected on the basis of the color profile.

Therefore, the image forming apparatus 1 can form an image with higher image quality.

Furthermore, in the image forming apparatus 1, the reader 32 is arranged on the upstream side in the sheet conveyance direction relative to the corrector 35 and the detector 33 in the image reading device 30.

This enables the controller 26 or the controller 31 to acquire the image reading result of the reader 32 at an earlier stage. Therefore, the controller 26 or the controller 31 can execute processing and control to be executed by using the image reading result of the reader 32 at an earlier stage.

### Second Embodiment

A second embodiment will be described with reference to the drawings.

The second embodiment exemplifies an image reading device 30 in which the arrangement of the detector 33 and the corrector 35 is changed.

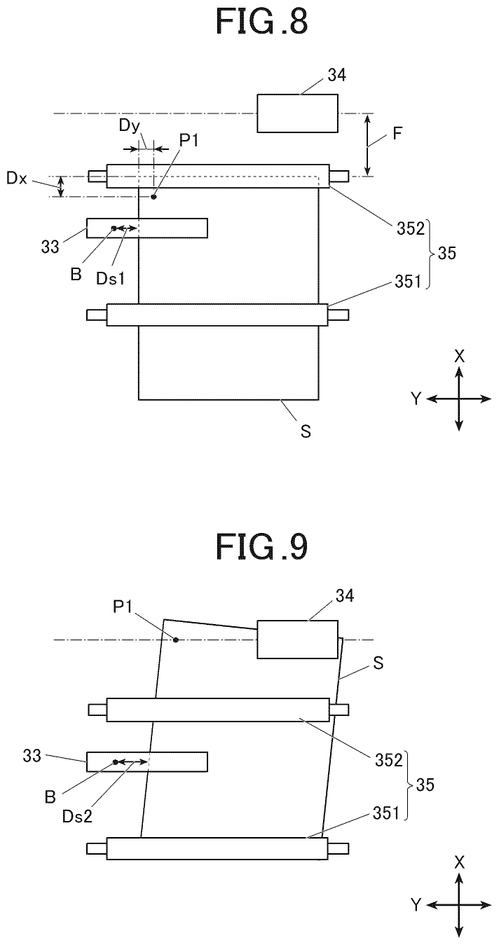

FIG. 8 is a schematic diagram illustrating a configuration of the image reading device 30 arranged in the second conveyance path 38.

In the image reading device 30 according to the first embodiment described above, the corrector 35 is arranged on the upstream side in the sheet conveyance direction relative to the detector 33. To be more specific, a registration roller 352 located at the downstream-side end in the sheet conveyance direction of the corrector 35 is arranged on the upstream side in the sheet conveyance direction relative to the detector 33.

FIG. 8 illustrates arrangement of the corrector 35 and the detector 33 in the image reading device 30 according to the second embodiment.

That is, the corrector 35 is arranged up to the downstream side in the sheet conveyance direction relative to the detector 33.

To be more specific, the registration roller 352 of the corrector 35 is arranged on the downstream side in the sheet conveyance direction relative to the detector 33. On the other hand, the loop roller 351 located at the upstream-side end in the sheet conveyance direction of the corrector 35 is arranged on the upstream side in the sheet conveyance direction relative to the detector 33.

That is, as illustrated in FIG. 8 and FIG. 9, the image reading device 30 includes the detector 33 arranged between the registration roller 352 and the loop roller 351.

Therefore, the corrector 35 and the detector 33 can be intensively arranged in the sheet conveyance direction. This enables the image reading device 30 to reduce the size of the second conveyance path 38 in which the corrector 35 and the detector 33 are arranged. Furthermore, the image reading device 30 can be downsized.

However, the detector 33 is arranged away from the colorimeter 34 in the sheet conveyance direction. On the other hand, the sheet S may have a skew again by the conveyance skew after the skew correction by the corrector 35.

In this case, since the detector 33 and the colorimeter 34 are separated from each other, there is a problem in that the image reading device 30 is greatly affected by the skew of the sheet S.

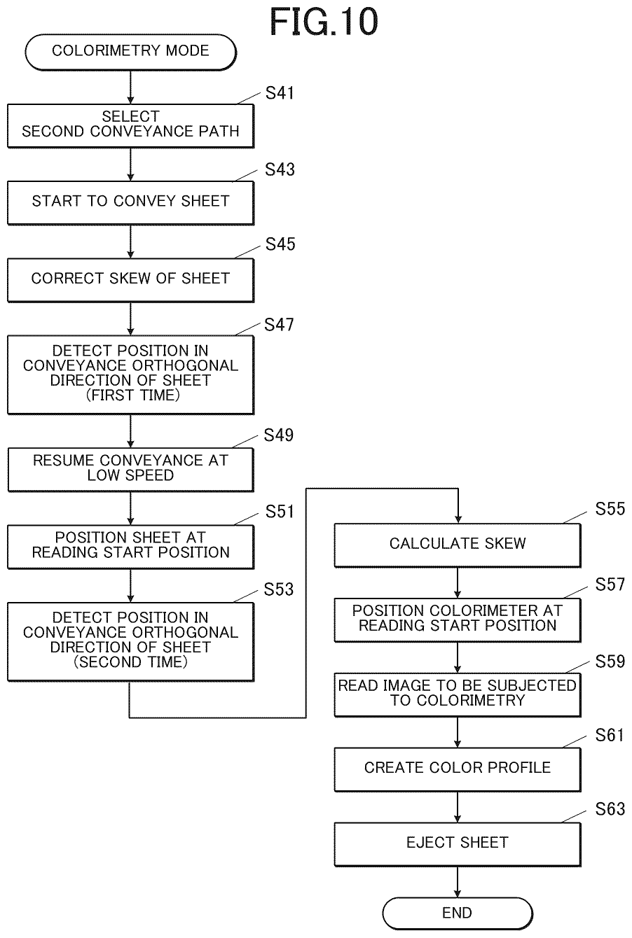

FIG. 9 illustrates a state where after the skew correction by the corrector 35, the sheet S has been conveyed to a reading start position which is a position of a patch P1. FIG. 10 is a flowchart illustrating reading processing of the chart image O executed by the controller 31 in order to solve the above-described problem.

The reading processing of the chart image O is executed by the CPU of the controller 31 according to a program read from the storage 27 of the main body 20 by the CPU.

Note that the CPU of the controller 31 executes the reading processing when the colorimetry mode is selected by the operator.

The controller 31 allows the sheet S to be conveyed to the second conveyance path 38 (S41).

Next, the controller 31 starts conveyance of the sheet S on which the chart image O is formed (S43).

When the sheet S arrives at the corrector 35, the corrector 35 performs the skew correction (S45).

Then, the controller 31 performs the first detection of the position in the conveyance orthogonal direction of the side end s1 by the detector 33 with respect to the sheet S immediately after the skew correction (S47: See FIG. 8).

Thus, the controller 31 acquires the position Ds1 in the conveyance orthogonal direction of the side end s1 of the sheet S.

Then, the controller 31 drives the registration roller 352 and the loop roller 351 to resume the conveyance at a low speed (S49).

The controller 31 performs positioning of the patch P1 of the sheet S with respect to the colorimeter 34 in the sheet conveyance direction and stops the conveyance (S51: See FIG. 9). The controller 31 can position the patch P1 on the colorimeter 34 by conveying the sheet S immediately after the skew correction by the distance (F+Dx) in the sheet conveyance direction.

As described above, the distance F is a distance from the registration roller 352 to the colorimeter 34 in the sheet conveyance direction. In addition, the distance Dx is a distance in the sheet conveyance direction from the downstream-side end in the sheet conveyance direction of the sheet S to the position of the patch P1.

Then, the controller 31 performs the second detection of the position in the conveyance orthogonal direction of the side end s1 by the detector 33 (S53: See FIG. 9). Thus, the controller 31 acquires the position Ds2 in the conveyance orthogonal direction of the side end s1 of the sheet S.

Next, the controller 31 calculates the skew of the sheet S on the basis of the positions Ds1 and Ds2 in the conveyance orthogonal direction of the side end s1 of the sheet S in the conveyance orthogonal direction and the conveyance distance (F+Dx) of the sheet S therebetween (S55).

That is, while moving by the distance (F+Dx) in the sheet conveyance direction, the sheet S moves by Ds2−Ds1 in the conveyance orthogonal direction.

Therefore, the controller 31 calculates the skew by the following expression (1).

$$Skew = ( Ds 2 - Ds 1 ) / ( F + Dx ) \qquad ( 1 )$$

The controller 31 may multiply the conveyance distance in the sheet conveyance direction from the time point when the skew correction of the sheet S is performed by the skew of the above expression (1). This enables the controller 31 to calculate the correction amount in the conveyance orthogonal direction of the sheet S that changes according to the conveyance distance of the sheet S in the sheet conveyance direction from the time point when the skew correction of the sheet S is performed.

Note that depending on the sheet type, there are some cases where the controller 31 cannot make a full correction by the above correction. In this case, a correction table for each sheet type may be prepared in a storage device, and the controller 31 may make a correction with reference to this. The sheet type may be input by a user in advance. Alternatively, a detection device capable of detecting the sheet type may be provided in the image reading device 30 or an apparatus on the upstream side, and the controller 31 may make a correction according to the sheet type.

The controller 31 corrects the position of the patch P1 according to the skew of the sheet S. Then, the colorimeter 34 is positioned at the corrected position in the conveyance orthogonal direction of the patch P1 (S57).

Next, the controller 31 causes the colorimeter 34 to read the chart image O (S59).

Note that even after the correction of the position of the patch P1, the skew of the sheet S may change according to the conveyance in the sheet conveyance direction. In this case, the controller 31 sequentially calculates the skew and performs the reading by the colorimeter 34 while correcting the position of each patch P.

After the reading of the chart image O is completed, the controller 31 creates a color profile of the image former 24 by comparing the read date with the image date of the chart image O (S61). The controller 31 transmits the color profile to the controller 26 of the main body 20.

Next, the controller 31 ejects the sheet S (S63), and ends the reading processing.

In the image reading device 30, the controller 31 causes the detector 33 to perform detection after the skew correction by the corrector 35 and at the time of reading of the patch P1 by the colorimeter 34. Next, the controller 31 obtains the skew of the sheet S on the basis of the two detection results. Furthermore, the controller 31 corrects the reading position by the colorimeter 34.

Therefore, even if the sheet S has a skew due to a conveyance skew or the like after the skew correction, the controller 31 can accurately perform reading of each patch P by the colorimeter 34.

In particular, as illustrated in FIG. 8, even in a case of a configuration in which the colorimeter 34 is likely to be influenced by the skew of the sheet S, the controller 31 can accurately perform reading of the colorimeter 34.

Note that the above-described reading processing involving the correction due to the skew of the sheet S may also be applied to the image reading device 30 having the configurations in FIG. 1. In the case of the image reading device 30 in FIG. 1, the influence of the skew of the sheet S is small. However, the image reading device 30 in FIG. 1 can also read the chart image O while further reducing the influence of the skew of the sheet S.

### [Others]

Note that the image forming apparatus or the image reading device is not limited to the above-described configuration.

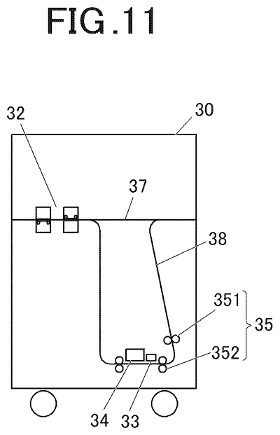

For example, as in an image reading device 30 of FIG. 11, the reader 32 may be arranged on the downstream side in the sheet conveyance direction relative to the colorimeter 34. In this case, in the image reading device 30, reading by the reader 32 is not performed immediately after image formation. In addition, in the case of this arrangement, the skew of the sheet S can be corrected by the corrector 35 before reading by the reader 32. Except for these points, the image reading device 30 in FIG. 11 produces the same technical effects as the image reading device 30 in FIG. 1 or FIG. 8.

Furthermore, the detector 33 may be arranged on the downstream side in the sheet conveyance direction of the colorimeter 34. For example, the patches P may be formed on the sheet S so as to be separated from the downstream-side end in the sheet conveyance direction of the sheet S. In such a case, reading by the colorimeter 34 can be accurately performed on the basis of the detection result of the detector 33.

In addition, the image reading device 30 is not limited to a configuration in which the colorimeter 34 is supported to be movable in the conveyance orthogonal direction.

For example, the image reading device may have an elongated colorimeter capable of reading the entire width in the conveyance orthogonal direction of the sheet S to be conveyed. In this case, the colorimeter 34 is fixedly arranged, and does not need to be positioned by conveyance. For example, the controller 31 reads the chart image O while identifying which patch P the detection result at each position in the conveyance orthogonal direction of the elongated detection surface of the colorimeter corresponds to.

In addition, the image reading device 30 may include another corrector which is a corrector different from the correctors 35 in FIG. 4 and can correct the skew of the sheet S. For example, the corrector may be configured to include two rollers arranged in the conveyance orthogonal direction and speed-controllable motors individually provided for the respective rollers. In this case, the controller 31 can correct the skew of the sheet S by instructing the two motors to rotate at different speeds so that the rollers feed the sheet S.

Note that in the case of the corrector, the image reading device 30 preferably detects the skew of the sheet S with respect to the sheet conveyance direction. For example, the image reading device 30 may include two detectors having the same configuration as the detector 33 at different positions in the sheet conveyance direction. The controller 31 can obtain the skew of the sheet S with respect to the sheet conveyance direction from each position of the side end s1 of the sheet S in the two detectors.

Furthermore, in each of the embodiments, the control of switching between the conveyance in the second conveyance path 38 and the conveyance in only the first conveyance path 37 in the colorimetry mode and the non-colorimetry mode has been exemplified. However, the controller 31 may perform another control. For example, the controller 31 may perform control to convey the sheet S to the second conveyance path 38 in any of the colorimetry mode and the non-colorimetry mode. Furthermore, in that case, the image reading device 30 may be configured to have only a conveyance path that passes through the second conveyance path 38. In that case, the image reading device 30 reduces the two systems of conveyance paths to one system, and the image reading device 30 can achieve simplification of the device configuration. In addition, the image reading device 30 does not require a device for switching the conveyance path. Furthermore, the controller 31 does not need to perform control for switching the conveyance path.

In addition, even in the case of the non-colorimetry mode, the controller 31 may perform the skew correction of the sheet by the corrector 35. In this case, even when an operator selects the non-colorimetry mode, the controller 31 can optimize the direction of conveyance of the sheet S.

Furthermore, the controller 31 may perform the sheet detection by the detector 33 even in the non-colorimetry mode. In this case, even when the operator selects the non-colorimetry mode, the controller 31 can obtain information on the conveyance state of the sheet S.

In addition, the detailed configuration of each device constituting the image forming apparatus 1 and the detailed operation of each device can be appropriately modified without departing from the spirit and scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image reading device, comprising:
a conveyance path along which a recording medium is conveyed;
a colorimeter that reads an image to be subjected to colorimetry, the image being recorded on the recording medium conveyed on the conveyance path;
a detector that detects a position of the recording medium in a direction intersecting a conveyance direction of the recording medium; and
a first hardware processor that controls the colorimeter so as to read the image to be subjected to colorimetry on a basis of a detection result by the detector.

2. The image reading device according to claim 1, wherein the first hardware processor controls a reading position by the colorimeter on a basis of the detection result by the detector.

3. The image reading device according to claim 1, wherein the colorimeter is movable along a direction intersecting the conveyance direction.

4. The image reading device according to claim 3, wherein the first hardware processor adjusts a reading position by the colorimeter in the direction intersecting the conveyance direction, on a basis of the detection result by the detector.

5. The image reading device according to claim 3, wherein
a plurality of the images to be subjected to colorimetry are recorded on the recording medium along the direction intersecting the conveyance direction; and
the colorimeter moves in the direction intersecting the conveyance direction to read each of the images to be subjected to colorimetry.

6. The image reading device according to claim 5, wherein the first hardware processor controls a position at which the colorimeter starts to read the image to be subjected to colorimetry on a basis of the detection result by the detector.

7. The image reading device according to claim 5, wherein the first hardware processor adjusts, on a basis of the detection result by the detector, a position of the colorimeter in the direction intersecting the conveyance direction before the colorimeter starts to read the image to be subjected to colorimetry.

8. The image reading device according to claim 1, wherein the detector is located on an upstream side in the conveyance direction relative to the colorimeter.

9. The image reading device according to claim 1, wherein the first hardware processor is capable of executing a colorimetry mode in which the image to be subjected to colorimetry is read by the colorimeter and a non-colorimetry mode in which the image to be subjected to colorimetry is not read.

10. The image reading device according to claim 1, further comprising a corrector that is located on an upstream side in the conveyance direction relative to the colorimeter and corrects a skew of the recording medium conveyed on the conveyance path.

11. The image reading device according to claim 10, wherein the detector is located on a downstream side in the conveyance direction relative to the corrector.

12. The image reading device according to claim 11, wherein the detector detects a position of the recording medium after the skew is corrected by the corrector.

13. The image reading device according to claim 10, wherein
the first hardware processor
is capable of executing a colorimetry mode in which the image to be subjected to colorimetry is read by the colorimeter and a non-colorimetry mode in which the image to be subjected to colorimetry is not read, and
in the colorimetry mode, executes correction by the corrector and detection by the detector, and in the non-colorimetry mode, does not execute at least any one of correction by the corrector and detection by the detector.

14. The image reading device according to claim 13, wherein the first hardware processor performs control so that a conveyance speed of the recording medium when the recording medium passes through the colorimeter in the colorimetry mode is lower than the conveyance speed in the non-colorimetry mode.

15. The image reading device according to claim 10, wherein
the first hardware processor controls a reading position by the colorimeter on a basis of a skew of the recording medium calculated on the basis of
a detection result obtained by the detector in a conveyance stopped state of the recording medium after correction by the corrector, and
a detection result then obtained by the detector in a conveyance stop state of the recording medium at a time of reading by the colorimeter.

16. An image forming apparatus, comprising:
an image former that records an image on a recording medium;
a conveyance path along which the recording medium is conveyed;
a colorimeter that reads an image to be subjected to colorimetry, the image being recorded, by the image former, on the recording medium conveyed on the conveyance path;
a detector that detects a position of the recording medium in a direction intersecting a conveyance direction of the recording medium; and
a first hardware processor that controls the colorimeter so as to read the image to be subjected to colorimetry on a basis of a detection result by the detector.

17. The image forming apparatus according to claim 16, further comprising:
a reader that reads an image recorded on the recording medium by the image former; and
a second hardware processor that corrects image formation by the image former on a basis of a reading result of the image by the reader.

18. The image forming apparatus according to claim 17, wherein the second hardware processor corrects and performs image formation by the image former on the basis of a reading result of the image to be subjected to colorimetry by the colorimeter and a reading result of the image by the reader.

19. The image forming apparatus according to claim 16, further comprising: a corrector that is located on an upstream side in the conveyance direction relative to the colorimeter and corrects a skew of the recording medium conveyed on the conveyance path.

20. The image forming apparatus according to claim 19, further comprising:
a reader that reads an image recorded on the recording medium by the image former; and
a second hardware processor that corrects image formation by the image former on a basis of a reading result of the image by the reader,
wherein
the reader is located on an upstream side in the conveyance direction relative to the corrector and the detector.

21. The image forming apparatus according to claim 16, further comprising:
a reader that reads an image recorded on the recording medium by the image former; and
an image controller that corrects image formation by the image former on a basis of a reading result of the image by the reader,
wherein
the reader is located on a downstream side in the conveyance direction relative to the colorimeter.
